(19) United States
(12) Patent Application Publication
(10) Pub. No.: US 2022/0113943 A1
(43) Pub. Date: Apr. 14, 2022

(54) METHOD FOR MULTIPLY-ADD OPERATIONS FOR NEURAL NETWORK

(71) Applicant: BEIJING BAIDU NETCOM SCIENCE TECHNOLOGY CO., LTD., Beijing (CN)

(72) Inventors: Guanglai Deng, Beijing (CN); Chao Tian, Beijing (CN)

(73) Assignee: BEIJING BAIDU NETCOM SCIENCE TECHNOLOGY CO., LTD., Beijing (CN)

(21) Appl. No.: 17/455,100

(22) Filed: Nov. 16, 2021

(30) Foreign Application Priority Data
Dec. 11, 2020 (CN) 202011460424.8

(51) Int. Cl. G06F 7/544; G06F 7/487; G06F 7/485; G06F 5/01; G06N 3/063

(52) U.S. Cl. CPC G06F 7/5443; G06F 7/4876; G06N 3/063; G06F 5/012; G06F 7/485

(57) ABSTRACT

The disclosure provides a method for multiply-add operations for a neural network. The method includes: determining types of respective pieces of data to be calculated based on a multiply-add operation request; in a condition of the type of each piece of the data to be calculated is a type of single-precision floating point, compressing mantissa of each pieces of the data to be calculated to obtain each compressed mantissa; splitting each compressed mantissa according to a preset rule and determining high digits and low digits of the compressed mantissa; and performing a multiply-add operation on each compressed mantissa based on the high digits and low digits of the compressed mantissa.

### CROSS REFERENCE TO RELATED APPLICATION

This application is based on and claims priority to Chinese patent application No. 202011460424.8, filed on Dec. 11, 2020, the entire content of which is hereby introduced into this application as a reference.

### TECHNICAL FIELD

The disclosure relates to a field of computer technologies, specifically to a field of artificial intelligence technologies such as deep learning, and in particular to a method for multiply-add operations for a neural network.

### BACKGROUND

For deep learning and neural networks, there are a large number of operations on a convolutional layer, and a multiply-add unit is a core component for completing the convolution operations.

When multiply-add operations is performed on data in the neural network, hardware resource cost is proportional to accuracy of a chip. In a condition of improving the accuracy of the chip, the hardware resource cost and power consumption are increased, for example, during speech data processing.

### SUMMARY

The embodiments of this disclosure provide a method for multiply-add operations for a neural network.

Embodiments of the disclosure in a first aspect provide a method for multiply-add operations for a neural network. The method includes: determining types of respective pieces of data to be calculated based on a multiply-add operation request; in a condition of the type of each piece of the data to be calculated is a type of single-precision floating point, compressing mantissa of each piece of the data to be calculated to obtain each compressed mantissa, in which each compressed mantissa contains less than or equal to 16 bits; splitting each compressed mantissa according to a preset rule and determining high digits and low digits of the compressed mantissa; and performing a multiply-add operation on each compressed mantissa based on the high digits and low digits of the compressed mantissa.

Embodiments of the disclosure in a second aspect provide an electronic device. The electronic device includes: at least one processor and a memory communicatively coupled to the at least one processor. The memory stores instructions executable by the at least one processor. When the instructions are implemented by the at least one processor, the at least one processor is configured to: determine types of respective pieces of data to be calculated based on a multiply-add operation request; a condition of the type of each piece of the data to be calculated is a type of single-precision floating point, compress mantissa of each piece of the data to be calculated to obtain each compressed mantissa, in which each compressed mantissa contains less than or equal to 16 bits; split each compressed mantissa according to a preset rule and determine high digits and low digits of the compressed mantissa; and perform a multiply-add operation on each compressed mantissa based on the high digits and low digits of the compressed mantissa.

Embodiments of the disclosure in a third aspect provide a non-transitory computer-readable storage medium storing computer instructions. The computer instructions are used to make the computer implement a method for multiply-add operations for a neural network, and the method includes: determining types of respective pieces of data to be calculated based on a multiply-add operation request; in a condition of the type of each piece of the data to be calculated is a type of single-precision floating point, compressing mantissa of each piece of the data to be calculated to obtain each compressed mantissa, in which each compressed mantissa contains less than or equal to 16 bits; splitting each compressed mantissa according to a preset rule and determining high digits and low digits of the compressed mantissa; and performing a multiply-add operation on each compressed mantissa based on the high digits and low digits of the compressed mantissa.

Additional effects of the above-mentioned optional manners are described below in combination with specific embodiments.

### BRIEF DESCRIPTION OF THE DRAWINGS

The drawings are used to better understand the solution and do not constitute a limitation to the disclosure, in which:

FIG. 1 is a flowchart of a method for multiply-add operations for a neural network according to embodiments of the disclosure.

FIG. 2 is a flowchart of another method for multiply-add operations for a neural network according to embodiments of the disclosure.

FIG. 3 is a flowchart of another method for multiply-add operations for a neural network according to embodiments of the disclosure.

FIG. 4 is a flowchart of another method for multiply-add operations for a neural network according to embodiments of the disclosure.

FIG. 5 is a schematic diagram of a process of multiply-add operations of a speech recognition scene according to embodiments of the disclosure.

FIG. 6 is a schematic diagram of an apparatus for multiply-add operations for a neural network according to embodiments of the disclosure.

FIG. 7 is a block diagram of an electronic device configured to implement the embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

Artificial intelligence is a subject for studying using computers to simulate certain thought processes and intelligent behaviors (such as learning, reasoning, thinking and planning) of humans, which involves both hardware-level technologies and software-level technologies. The hardware technologies for the artificial intelligence generally includes several directions such as sensors, dedicated artificial intelligence chips, cloud computing, distributed storage, deep learning, big data processing technologies, and knowledge graph technologies.

The deep learning is a new research direction in the field of machine learning, which is used to learn internal laws and hierarchical representations of sample data. Information obtained in the learning process is of great help to interpretation of data such as text, images and sounds. An ultimate goal for the deep learning is to enable machines to have capabilities of analyzing and learning like humans, and recognizing data such as text, images, and sounds.

The method for multiply-add operations for a neural network and the apparatus for multiply-add operations for a neural network according to embodiments of the disclosure are described below with reference to the drawings.

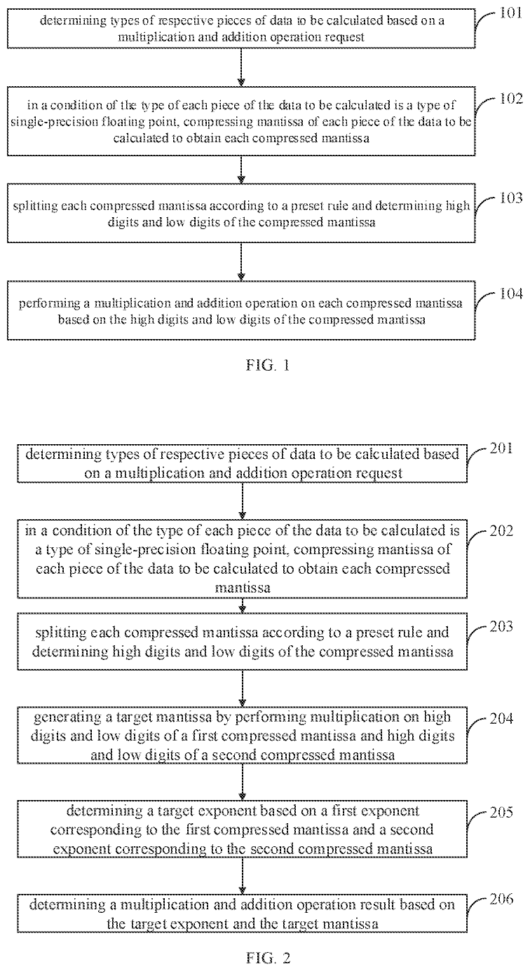

FIG. 1 is a flowchart of a method for multiply-add operations for a neural network according to embodiments of the disclosure.

The method for multiply-add operations for the neural network according to the embodiments of the disclosure is executed by the apparatus for multiply-add operations for the neural network according to embodiments of the disclosure. The apparatus is configured in an electronic device to realize high-precision operations under a premise of saving hardware resource cost and power consumption, and to complete convolutional operations of the neural network.

The method for multiply-add operations for the neural network according to the embodiments of the disclosure is applied to a variety of neural networks, such as neural networks based on deep learning.

As illustrated in FIG. 1, the method for multiply-add operations for the neural network includes the following blocks.

At block 101, types of respective pieces of data to be calculated are determined based on a multiply-add operation request.

Data operations in the neural network may include operations on a variety of types of data, such as integer data, single-precision floating-point data, and so on.

In an embodiment, when the neural network is trained or the neural network is used for prediction, the data is input into the neural network, and when the multiply-add operation is performed, the types of respective pieces of data to be calculated are determined in response to the obtained multiply-add operation request.

When determining the types of respective pieces of data to be calculated, the type of each piece of data to be calculated may be determined based on data format of each piece of data to be calculated. For example, data of standard single-precision floating-point occupies 4 bytes (i.e., 32 bits) in a memory of a computer, and data of int8 type is stored in 8 bits.

At block 102, in a condition of the type of each piece of the data to be calculated is a type of single-precision floating point, mantissa of each piece of the data to be calculated is compressed to obtain each compressed mantissa.

Since the data of the single-precision floating point type contains 32 bits, bit width of which is relatively large, so bit width of a multiplying unit is relatively large, which requires high hardware resource cost and power consumption.

In an embodiment, when the types of respective pieces of data to be calculated is the type of single-precision floating point, the mantissa of each piece of data to be calculated is compressed to reduce the bit width of the data and obtain each compressed mantissa. For example, each compressed mantissa is less than or equal to 16 bits.

For 32-bit length bytes of the single-precision floating-point data, a highest bit is a sign bit, middle 8 bits represent an exponent, and lowest 23 bits represent the mantissa. For example, for speech processing, the mantissa of the single-precision floating-point data is compressed from 23 bits to 15 bits, and the 15-bit mantissa meets precision requirements of the neural network used in the speech processing.

It should be noted that compressing the mantissa to 15 bits is only an example. In practical applications, the mantissa may be compressed to a corresponding number of bits, according to the type of a specific application, when the precision requirements are met.

In an embodiment, when the type of each piece of the data to be calculated is the type of single-precision floating point, the mantissa of each piece of the data to be calculated is compressed, so that each compressed mantissa meets the precision requirements of the neural network. Moreover, the bit width of the mantissa is reduced due to compressing the mantissa, which shortens the bit width of the multiplying unit and is of great help in saving hardware area of the chips.

At block 103, each compressed mantissa is split according to a preset rule and high digits and low digits of the compressed mantissa are determined.

In order to save the hardware resource cost, the multiplying unit with a small bit width is used for multiplication. In an embodiment, each compressed mantissa is split according to the preset rule, and the compressed mantissa is split into the high digits and the low digits.

In detail, the compressed mantissa is split into the high digits and the low digits according to the bit width of the multiplying unit and the number of bits of the compressed mantissa. For example, the multiplying unit with 8 bits is used, and the mantissa is compressed to 15 bits, in response to the exponent being 0, 0 is added to in front of the compressed 15-bits mantissa to obtain a 16-bits mantissa, and in response to the exponent not being 0, 1 is added to in front of the compressed 15-bits mantissa to obtain the 16-bits mantissa. To complete multiplication of 16-bits with 16-bits, the 16 bits may be split into highest 8 bits and lowest 8 bits. When the compressed mantissa is 7 bits, it may not split the mantissa.

At block 104, a multiply-add operation is performed on each compressed mantissa based on the high digits and low digits of the compressed mantissa.

After determining the high digits and low digits of the compressed mantissa, multiplication operations are performed on the compressed mantissas based on the high digits and low digits of each compressed mantissa, and addition operations are performed according to results of the multiplication operations to obtain results of the multiply-add operations.

In an embodiments of the present disclosure, the type of each piece of data to be calculated is determined based on the multiply-add operation request. In the condition of the type of each piece of the data to be calculated is the type of the single-precision floating point, the mantissa of each piece of the data to be calculated is compressed to obtain each compressed mantissa. Each compressed mantissa is split according to the preset rule, and the high digits and the low digits of the compressed mantissa are determined. The multiply-add operation is performed on each compressed mantissa based on the high digits and low digits of the compressed mantissa. Therefore, during performing the multiply-add operations, when the type of each piece of the data to be calculated is the type of single-precision floating point, the mantissa is compressed. As the bit width of the mantissa is reduced, the bit width of the multiplying unit is shortened. The high-precision operation is achieved under the premise of saving hardware resource cost and power consumption, and the convolutional operation for of the neural network is completed, which may have a short operand, occupy less memory, reduce operation overhead, and speed up operation.

In an embodiment of the present disclosure, when the multiply-add operation is performed, high digits and low digits of a first compressed mantissa are multiplied by high digits and low digits of a second compressed mantissa. The result of the multiply-add operation is obtained according to the multiplication result and the exponents corresponding to the two compressed mantissas respectively. FIG. 2 is a flowchart of another method for multiply-add operations for a neural network according to embodiments of the disclosure.

As illustrated in FIG. 2, the method for multiply-add operations for the neural network includes the following blocks.

At block 201, types of respective pieces of data to be calculated are determined based on a multiply-add operation request.

At block 202, in a condition of the type of each piece of the data to be calculated is a type of single-precision floating point, mantissa of each piece of the data to be calculated is calculated to obtain each compressed mantissa.

At block 203, each compressed mantissa is split according to a preset rule and high digits and low digits of the compressed mantissa are determined.

In an embodiment, block 201 to block 203 are similar to the block 101 to block 103, which will not repeat here.

At block 204, a target mantissa is generated by multiplying high digits and low digits of a first compressed mantissa by high digits and low digits of a second compressed mantissa.

In an embodiment, the high digits of any compressed mantissa is multiplied by the high digits and low digits of another compressed mantissa respectively, and the low digits of any compressed mantissa is multiplied by the high digits and low digits of another compressed mantissa respectively, and the target mantissa is generated.

In detail, first target high digits are determined by multiplying the high digits of the first compressed mantissa by the high digits of the second compressed mantissa. Second target high digits are determined by multiplying the high digits of the first compressed mantissa by the low digits of the second compressed mantissa. Third target high digits are determined by multiplying the low digits of the first compressed mantissa with the high digits of the second compressed mantissa. Target low digits are determined by multiplying the low digits of the first compressed mantissa by the low digits of the second compressed mantissa. After obtaining the first target high digits, the second target high digits, the third target high digits and the target low digits, the target mantissa is generated based on the first target high digits, the second target high digits, the third target high digits and the target low digits. In detail, first shifted high digits are obtained by shifting the first target high digits to left by a first preset number of bits. Two second shifted high digits are obtained by respectively shifting the second target high digits and the third target high digits to left by a second preset number of bits. The target mantissa is generated by adding the first shifted high digits, the two second shifted high digits and the target low digits.

The first preset number of bits and the second preset number of bits are determined according to the number of bits of the target low digits, and the second preset number of bits is less than the first preset number of bits.

For example, two compressed mantissas A and B are of 16 bits, the compressed mantissa A is split into highest 8 bits and lowest 8 bits, which are represented by A_H and A_L respectively. The compressed mantissa B is split into highest 8 bits and lowest 8 bits, which are represented by B_H and B_L respectively. During the multiply-add operation, the first target high digits are HH=A_H*B_H, the second target high digits are HL=A_H*B_L, the third target high digits are LH=A_L*B_H, and the target high digits are LL=A_L*B_L. After obtaining the HH, HL, LH and LL, HH is shifted to the left by 16 bits, and both HL and LH are shifted to the left by 8 bits, then the target mantissa of the result of the multiply-add operation of the two compressed mantissas A and B may be HH<<16+HL<<8+LH<<8+LL. HH<<16 denotes to shift HH to the left by 16 bits, and HL<<8 denotes to shift HL to the left by 8 bits.

In an embodiment, by performing multiplication on the high digits and low digits of the two compressed mantissas, the corresponding high digits and low digits are obtained. the target low digits are generated according to the obtained high digits and low digits, thus a method for calculating the target mantissa based on the two compressed mantissas is provided. Moreover, the high digits obtained by the multiplication are shifted by the corresponding number of bits, the shifted high digits and the target low digits are added to obtain the target mantissa, so that the mantissa of the result of multiply-add operation is obtained by performing multiplication on the high digits and low digits of the compressed mantissas.

At block 205, a target exponent is determined based on a first exponent corresponding to the first compressed mantissa and a second exponent corresponding to the second compressed mantissa.

For the multiply-add operation of single-precision floating-point data, index, namely, the exponent, is required to be considered. In an embodiment, the target exponent is determined based on the first exponent corresponding to the first compressed mantissa and the second exponent corresponding to the second compressed mantissa. That is, the target exponent is obtained by adding the exponents of two pieces of single-precision floating-point data.

At block 206, a multiply-add operation result is determined based on the target exponent and the target mantissa.

In an embodiment, the target exponent is the exponent of the multiply-add operation result, and the target mantissa is the mantissa of the multiply-add operation result. When storing, the single-precision floating-point data may be divided into three parts: a sign bit, an exponent and a mantissa. According to the target exponent and the target mantissa, the multiply-add operation result is obtained.

In an embodiment, when the multiply-add operations are performed on the compressed mantissas based on the high digits and low digits of each compressed mantissa, the target mantissa is generated by multiplying the high digits and the low digits of the first compressed mantissa by the high digits and the low digits of the second compressed mantissa. The target exponent is determined based on the first exponent corresponding to the first compressed mantissa and the second exponent corresponding to the second compressed mantissa. The multiply-add operation result is determined based on the target exponent and the target mantissa. Therefore, by performing multiplication on the high digits and low digits of the two compressed mantissas, the target mantissa of the result of performing multiplication on the two single-precision floating-point data is obtained, thereby reducing the bit width of the multiplying unit and saving hardware resource cost and power consumption.

In an embodiment, when the target mantissa is generated by multiplying the high digits and the low digits of the first compressed mantissa by the high digits and the low digits of the second compressed mantissa, four multiplying units are called to perform multiplication on the high digits and low digits of the two compressed mantissas.

In detail, after the four multiplying units are called, a first multiplying unit is configured to multiply the high digits of the first compressed mantissa by the high digits of the second compressed mantissa, and a second multiplying unit is configured to multiply the high digits of the first compressed mantissa by the low digits of the second compressed mantissa, a third multiplying unit is configured to multiply the low digits of the first compressed mantissa by the high digits of the second compressed mantissa, and a fourth multiplying unit is configured to multiply the low digits of the first compressed mantissa by the low digits of the second compressed mantissa. Therefore, each multiplying unit generates one calculation result, thus four calculation results are obtained.

After the four calculation results are obtained, when performing the multiply-add operations, each calculation result obtained when a multiplicator or a multiplicand is the high digits is shifted. The specific method is referred to the above embodiments, which will not be repeated here. After the calculation result to be shifted is shifted, the results are added to generate the target mantissa.

For example, two pieces of data with single-precision floating-point are of 32 bits, each compressed mantissa is of 16 bits, and the compressed mantissa is split into highest 8 digits and lowest 8 digits, and four multiplying units with 8×8 are called. In other words, four multiplying units with bit width of 8 bits are called to multiply the highest 8 digits by the highest 8 digits, the highest 8 digits by the lowest 8 digits, the lowest 8 digits by the highest 8 digits, and the lowest 8 digits by the lowest 8 digits respectively to obtain four calculation results. After obtaining the four calculation results, a calculation result obtained by multiplying the highest 8 digits by the highest 8 digits is shifted to the left by 16 digits, and a calculation result obtained by multiplying the highest 8 digits by the lowest 8 digits, and a calculation result obtained by multiplying the lowest 8 digits by the highest 8 digits are shifted to the left by 8 digits, and the shifted results are added with a calculation result obtained by multiplying the lowest 8 digits by the lowest 8 digits to obtain the target mantissa. Therefore, by calling the four multiplying units with bit wide of 8 bits, multiplication for single-precision floating-point data is realized. Compared to conventional single-precision multiplication requiring using a multiplier with bit wide of 24 bits, the method of the present disclosure saves hardware resource cost and power consumption and improves the efficiency and utilization of hardware.

In embodiments of the present disclosure, when the high digits and low digits of the first compressed mantissa are multiplied by the high digits and low digits of the second compressed mantissa to generate the target mantissa, four multiplying units are called to multiply the high digits and low digits of the first compressed mantissa by the high digits and low digits of the second compressed mantissa to generate four calculation results. The four calculation results are shifted and added to generate the target mantissa. Thus, by calling four multiplying units with small bit width to perform multiplication on the two compressed mantissas, the hardware resource cost and power consumption are saved.

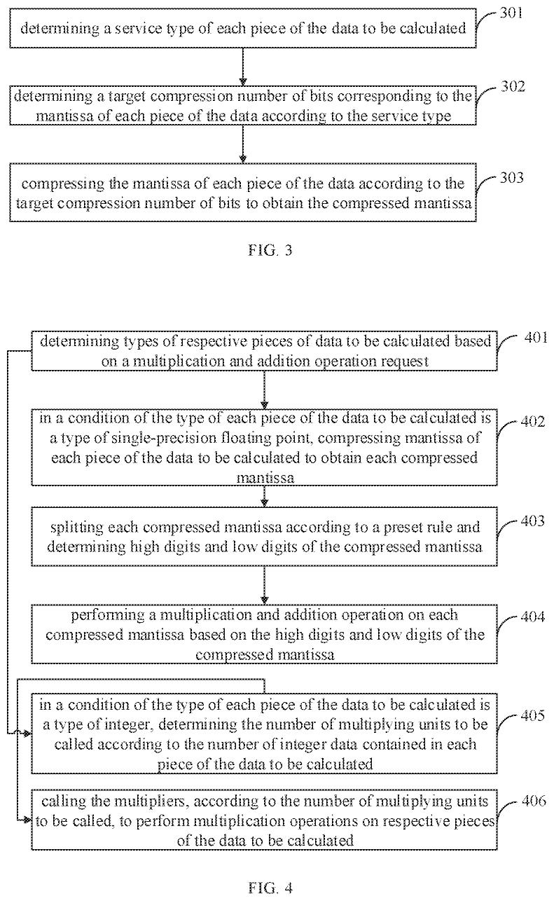

In order to meet individual requirements of the multiply-add operations, in an embodiment of the disclosure, when the mantissa of each piece of data to be calculated is compressed, the number of bits of the compressed mantissa is determined according to service type corresponding to each piece of data to meet the precision requirements of different service types. FIG. 3 is a flowchart of another method for multiply-add operations for a neural network according to embodiments of the disclosure.

As illustrated in FIG. 3, compressing the mantissa of each piece of data to be calculated to obtain each compressed mantissa includes the following blocks.

At block 301, service type of each piece of the data to be calculated is determined.

In an embodiment, the service type corresponding to each piece of data to be calculated may be determined according to input data of the neural network. For example, When the input data is speech data, the neural network is used for speech processing, and the service type is determined as speech processing. When the input data is image data, then the neural network is used for image processing, and the service type is determined as image processing.

At block 302, a target compression number of bits corresponding to the mantissa of each piece of the data is determined according to the service type.

In an embodiment, a corresponding relation between the service type and the compression number of bits is established in advance, the compression number of bits is understood as the number of bits of the compressed mantissa, and the compression number of bits may be different when corresponding to different service types. After obtaining the service type corresponding to each piece of data to be calculated, the target compression number of bits corresponding to each piece of data to be calculated may be determined according to the corresponding relation.

For example, when the service type of each piece of data to be calculated is speech processing, and the target compression number of bits corresponding to the speech processing is determined as 15 bits, then the mantissa of each piece of data to be calculated is compressed from 23 bits to 15 bits. The compressed mantissa is of 15 bits, which meets the precision requirements of the neural network used in the speech processing.

At block 303, the mantissa of each piece of the data is compressed, according to the target compression number of bits, to obtain the compressed mantissa.

In an embodiment, after the target compression number of bits is determined, the mantissa of each piece of data is compressed to the target compression number of bits by compressing the mantissa of each piece of data to be calculated. In detail, a preset number of low digits in the mantissa of each piece of data may be discarded, and the preset number is a difference between the number of bits of the mantissa of each piece of data and the target compression number of bits.

For example, the target compression number of bits is 15 bits, the mantissa of the data is of 23 bits. Then when compressing the mantissa of the data, the lowest 8 digits of the mantissa are discarded, and the highest 15 digits are reserved, and then the compressed mantissa with 15 digits is obtained.

After obtaining the compressed mantissa, the compressed mantissa is split, according to the preset rule, to determine the high digits and low digits in the compressed mantissa, and the multiply-add operations are performed on the compressed mantissas according to the high digits and the low digits of each compressed mantissa. The specific calculation method may refer to the embodiment illustrated in FIG. 2, which will not be repeated here.

In the embodiments of the disclosure, when the mantissa of each piece of data to be calculated is compressed to obtain each compressed mantissa, the service type corresponding to each piece of data to be calculated is determined, and the target compression number of bits corresponding to the mantissa of each piece of data is determined according to the service type, and the mantissa of each piece of data is compressed, according to the target compression number of bits, to obtain each compressed mantissa. Therefore, the compression number of bits is determined according to the service type corresponding to the single-precision floating-point data, and the mantissa is compressed according to the determined compression number of bits, therefore, realizing high-precision calculation on the basis of meeting the precision requirements of different service types, meeting individual requirements of the multiply-add operations of different service types.

In an embodiment of the disclosure, the multiply-add operations for data in the neural network, in addition to including the operations for the single-precision floating-point data, also supports the multiply-add operations for the integer data. FIG. 4 is a flowchart of another method for multiply-add operations for a neural network according to embodiments of the disclosure.

As illustrated in FIG. 4, the method for multiply-add operations for the neural network includes the following blocks.

At block 401, types of respective pieces of data to be calculated are determined based on a multiply-add operation request.

At block 402, in a condition of the type of each piece of the data to be calculated is a type of single-precision floating point, mantissa of each piece of the data to be calculated is calculated to obtain each compressed mantissa.

At block 403, each compressed mantissa is split according to a preset rule, and high digits and low digits of the compressed mantissa are determined.

At block 404, a multiply-add operation is performed on each compressed mantissa based on the high digits and low digits of the compressed mantissa.

In an embodiment, block 401-block 404 are similar to block 101-block 104, which will not be repeated here.

At block 405, in a condition of the type of each piece of the data to be calculated is a type of integer, the number of multiplying units to be called is determined according to the number of integer data contained in each piece of the data to be calculated.

In an embodiment, when the type of each piece of data to be calculated is the type of single-precision floating point, block 402-block 404 are performed.

When the type of each piece of data to be calculated is the type of integer, the number of multiplying units to be called is determined according to the number of integer data in each piece of data.

For example, when the data is of 32 bits, which includes four pieces of int8 data, it may be determined that the number of the multiplying units to be called is 4, and the bit width of each multiplying unit is of 8 bits. For another example, when the data is 24bits, which includes three pieces of int8 data, it may be determined that the number of the multiplying units to be called is 3, and the bit width of each multiplying unit is 8bits.

At block 406, the multiplying units are called according to the number of the multiplying units to be called, to perform multiplication operations on respective pieces of the data to be calculated.

In an embodiment, the multiplying units are used to perform one-to-one correspondence multiplication on integer data contained in any data and integer data contained in another piece of data. Each multiplying unit corresponds to one calculation result. The calculation results of all multiplying units are added to obtain the result of the multiplication operations. The one-to-one correspondence multiplication refers to perform multiplication on the integer data at the corresponding positions in the two pieces of data.

For example, when the number of multiplying units to be called is 4, and the bit width of each multiplying unit is 8 bits, then pour multiplying units may be called, and four pieces of data of the int8 type contained in any data are respectively multiplied by four pieces of data of the int8 type contained in another piece of data to obtain four calculation results. The four calculation results are added to obtain the multiplication operation result of the two integer data, the operation results are of 32 bits. When the data to be calculated is the single-precision floating-point data and the compressed mantissa contains 16 bits, four multiplying units with bit width of 8 bits may be used for multiplication. As a result, fusion multiplexing of the multiplying units is realized, and the efficiency and utilization of the hardware are improved.

In an embodiment, when the type of each piece of data to be calculated is the type of single-precision floating point, the mantissa of each piece of data to be calculated is compressed, and the multiply-add operations are performed on each compressed mantissa based on the high digits and low digits of the compressed mantissa. When the type of each piece of data to be calculated is the type of integer, the number of multiplying units to be called is determined according to the number of integer data contained in each piece of data, and the multiplying units are called, according to the number, to perform the multiplication operation on each piece of data to be calculated. As a result, the multiply-add operations for the neural network support operations for single-precision floating-point and integer data, and on the basis of saving hardware resources and power consumption, high-precision operations are realized, and the convolution operation of the neural network is completed.

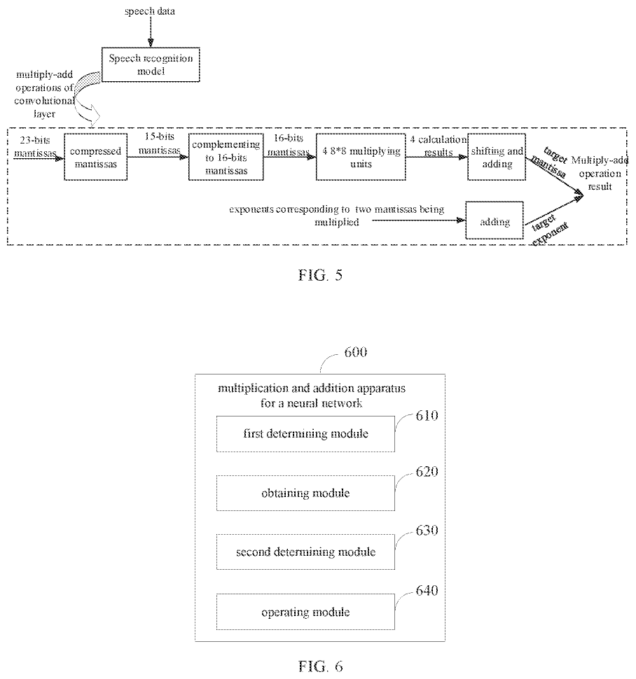

Taking a speech recognition scene as an example, the method for multiply-add operations used for the neural network is described with reference to FIG. 5.

As illustrated in FIG. 5, collected speech data is input into a speech recognition model for recognition. When a convolutional layer of the speech recognition model performs the multiply-add operations, based on each piece of speech data to be calculated is the he single-floating point precision data, the mantissa of the speech data is compressed from 23 bits to 15 bits, and each 15-bit mantissa corresponding to each piece of compressed speech data is obtained. After obtaining each compressed 15-bit mantissa, the compressed 15-bits mantissa is complemented to 16 bits according to whether the exponent is 0, and four 8*8 multiplying units are called to perform the multiplication operation on the 16-bit mantissa. When the multiplying unit is performing calculations, the highest 8 digits and lowest 8 digits of the first compressed mantissa are multiplied by the highest 8 digits and lowest 8 digits of the second compressed mantissa to generate four calculation results.

After obtaining the four calculation results, the four calculation results are shifted and added. The calculation result obtained by multiplying the highest 8 digits by highest 8 digits is shifted by 16 bits to the left, and the calculation result is obtained by multiplying the highest 8 digits and the lowest 8 digits, and the calculation result obtained by multiplying the lowest digits and the highest 8 digits is shifted by 8 bits to the left, and the shifted results are added with a calculation result obtained by multiplying the lowest 8 digits by the lowest 8 digits to obtain the target mantissa.

As illustrated in FIG. 5, the exponents corresponding to the two mantissas for multiplying are added to obtain the target exponent. After the target exponent and the target mantissa are obtained, the result of the multiply-add operation of the two speech data to be calculated is determined according to the target exponent and the target mantissa.

To implement the above embodiments, the embodiments of the disclosure further provide an apparatus for multiply-add operations for a neural network. FIG. 6 is a schematic diagram of an apparatus for multiply-add operations for a neural network according to embodiments of the disclosure.

As illustrated in FIG. 6, the apparatus for multiply-add operations for a neural network 600 includes: a first determining module 601, an obtaining module 602, a second determining module 603 and an operating module 604. The first determining module 601 is configured to determine types of respective pieces of data to be calculated based on a multiply-add operation request. The obtaining module 602 is configured to, in a condition of the type of each piece of the data to be calculated is a type of single-precision floating point, mantissa of each piece of the data to be calculated is calculated to obtain each compressed mantissa, in which each compressed mantissa contains less than or equal to 16 bits. The second determining module 603 is configured to split each compressed mantissa according to a preset rule and determine high digits and low digits of the compressed mantissa. The operating module 604 is configured to perform a multiply-add operation on each compressed mantissa based on the high digits and low digits of the compressed mantissa.

In an embodiment, the operating module 604 includes: a generating unit, a first determining unit and a second determining unit. The generating unit is configured to generate a target mantissa by performing multiplication on high digits and low digits of a first compressed mantissa and high digits and low digits of a second compressed mantissa. The first determining unit is configured to determine a target exponent based on a first exponent corresponding to the first compressed mantissa and a second exponent corresponding to the second compressed mantissa. The second determining unit is configured to determine a multiply-add operation result based on the target exponent and the target mantissa.

In an embodiment, the generating unit includes: a first generating subunit, a second generating subunit, a third generating subunit and a determining subunit. The first generating subunit is configured to generate first target high digits and second target high digits by multiplying the high digits of the first compressed mantissa by the high digits and the low digits of the second compressed mantissa respectively. The second generating subunit is configured to generate third target high digits by multiplying the low digits of the first compressed mantissa by the high digits of the second compressed mantissa. The third generating subunit is configured to generate target low digits by multiplying the low digits of the first compressed mantissa by the low digits of the second compressed mantissa. The determining subunit is configured to determine the target mantissa based on the first target high digits, the second target high digits, the third target high digits and the target low digits.

In an embodiment, the determining subunit configured to: obtain first shifted high digits by shifting the first target high digits to left by a first preset number of bits; obtain two second shifted high digits by shifting the second target high digits and the third target high digits respectively to left by a second preset number of bits, in which the second preset number of bits is less than the first preset number of bits; and generate the target mantissa by adding the first shifted high digits, the two second shifted high digits and the target low digits.

In an embodiment, the generating unit is configured to: call four multiplying units to perform multiplication on the high digits and low digits of the first compressed mantissa the high digits and low digits of the second compressed mantissa and generate four calculation results; and perform shifting and adding on the four calculation results to generate the target mantissa.

In an embodiment, the obtaining module 620 is configured to: determine a service type of each piece of the data to be calculated; determine a target compression number of bits corresponding to the mantissa of each piece of the data according to the service type; and compress the mantissa of each piece of the data according to the target compression number of bits to obtain the compressed mantissa.

In an embodiment, the apparatus further includes a third determining module, configured to, in a condition of the type of each piece of the data to be calculated is a type of integer, determine the number of multiplying units to be called according to the number of integer data contained in each piece of the data to be calculated.

The operating module 640 is configured to call the multiplying units, according to the number of multiplying units to be called, to perform multiplication operations on respective pieces of the data to be calculated.

It should be noted that the explanation of the above embodiments of the method for multiply-add operations for a neural network is also applicable to the apparatus for multiply-add operations for a neural network of the embodiments, which is not repeated herein.

With the apparatus for multiply-add operations for a neural network, types of respective pieces of data to be calculated are determined based on a multiply-add operation request. In a condition of the type of each piece of the data to be calculated is a type of single-precision floating point, mantissa of each piece of the data to be calculated is calculated to obtain each compressed mantissa. Each compressed mantissa is spitted according to a preset rule and high digits and low digits of the compressed mantissa are determined. A multiply-add operation is performed on each compressed mantissa based on the high digits and low digits of the compressed mantissa. Therefore, when performing the multiply-add operation, if each piece of data to be calculated is single-precision floating point, the mantissa is compressed. As bit width of the mantissa is reduced, the bit width of the multiplying unit is shortened. A high-precision operation is realized under the premise of saving hardware resource cost and power consumption, a convolutional operation is completed through cooperation and has a short operand, which occupies less memory, reduces operation overhead, and speeds up operation.

According to the embodiments of the disclosure, the embodiments of the disclosure provide an electronic device, a readable storage medium and a computer program product.

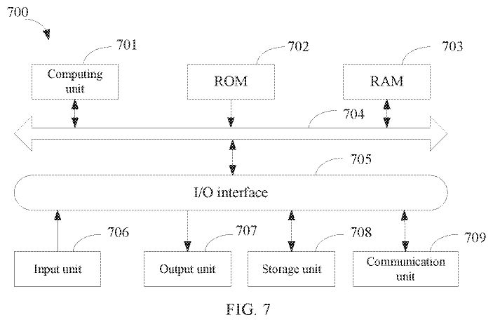

FIG. 7 is a block diagram of an electronic device 700 configured to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 13, the electronic device includes: a computing unit 701, which is configured to perform various appropriate actions and processes according to computer programs stored on a Read-Only Memory (ROM) 702 or computer programs loaded on a Random Access Memory (RAM) 703 from a storage unit 708. In the RAM 703, various programs and data required for the operation of the device 700 are stored. The computing unit 701, the ROM 702, and the RAM 703 are connected to each other through a bus 704. An Input/output (I/O) interface 705 is connected to the bus 704.

Components in the device 700 are connected to the I/O interface 705, including: an input unit 706, such as a keyboard, a mouse; an output unit 707, such as various types of displays, speakers; a storage unit 708, such as a disk, an optical disk; and a communication unit 709, such as network cards, modems, wireless communication transceivers, and the like. The communication unit 709 allows the device 700 to exchange information/data with other devices through a computer network such as the Internet and/or various telecommunication networks.

The computing unit 701 may be various general and/or dedicated processing components having processing and computing capabilities. Some examples of the computing unit 701 include, but are not limited to, a central processing unit (CPU), a graphics processing unit (GPU), various dedicated artificial intelligence (AI) computing chips, various computing units running machine learning model algorithms, and digital signal processor (DSP), and any suitable processor, controller, and microcontroller. The computing unit 701 performs various methods and processes described above, such as the method for multiply-add operations for a neural network. For example, in some embodiments, the method for multiply-add operations for a neural network may be implemented as computer software programs that are tangibly embodied on a machine-readable medium, such as the storage unit 708. In some embodiments, part or all of the computer program may be loaded and/or installed on the device 700 via the ROM 702 and/or the communication unit 709. When a computer program is loaded into the RAM 703 and executed by the computing unit 701, one or more steps of the method for multiply-add operations for a neural network described above may be performed. Alternatively, in other embodiments, the computing unit 701 may be configured to perform the method in any other suitable manner (e.g., by means of firmware).

Various implementations of the systems and techniques described above may be implemented by Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

Program code for implementing the method of the disclosure may be written in any combination of one or more programming languages. These program codes may be provided to a processor or controller of a general computer, a dedicated computer, or other programmable data processing device, such that the program codes, when executed by the processor or controller, cause the functions and/or operations specified in the flowcharts and/or block diagrams is performed. The program code can be executed entirely on the machine, partly on the machine, as a stand-alone software package partly on a machine and partly on a remote machine or entirely on a remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), erasable programmable read-only memories (EPROM or flash memory), fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, sound input, or tactile input).

The systems and technologies described herein can be implemented in a computing system that includes background components (for example, a data server), or a computing system that includes middleware components (for example, an application server), or a computing system that includes front-end components (For example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service system to solve difficult management and poor business expansion of traditional physical hosting and VPS services. The server may be a server of a distributed system, or a server combined with a block-chain.

The technical solution of the embodiments of the disclosure specifically relates to the field of artificial intelligence technology such as deep learning. When the multiply-add operation is performed, in a condition of the type of each piece of the data to be calculated is a type of single-precision floating point, the mantissa is compressed. The bit width is reduced, which shortens the bit width of the multiplying unit. Therefore, high-precision operation is realized while saving hardware resource cost and power consumption, and the convolution operation of the neural network is completed through cooperation. Shorter operands take up less memory, reduce operation overhead, and speed up calculations.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for multiply-add operations for a neural network, comprising:
determining types of respective pieces of data to be calculated based on a multiply-add operation request;
in a condition of the type of each piece of the data to be calculated is a type of single-precision floating point, compressing mantissa of each piece of the data to be calculated to obtain each compressed mantissa, wherein each compressed mantissa contains less than or equal to 16 bits;
splitting each compressed mantissa according to a preset rule and determining high digits and low digits of the compressed mantissa; and
performing a multiply-add operation on each compressed mantissa based on the high digits and low digits of the compressed mantissa.

2. The method according to claim 1, wherein performing the multiply-add operation on each compressed mantissa based on the high digits and the low digits in the compressed mantissa comprises:
generating a target mantissa by performing multiplication on high digits and low digits of a first compressed mantissa and high digits and low digits of a second compressed mantissa;
determining a target exponent based on a first exponent corresponding to the first compressed mantissa and a second exponent corresponding to the second compressed mantissa; and
determining a multiply-add operation result based on the target exponent and the target mantissa.

3. The method according to claim 2, wherein generating the target mantissa by performing multiplication on the high digits and low digits of the first compressed mantissa respectively and the high digits and low digits of the second compressed mantissa, comprises:
generating first target high digits and second target high digits by multiplying the high digits of the first compressed mantissa by the high digits and the low digits of the second compressed mantissa respectively;
generating third target high digits by multiplying the low digits of the first compressed mantissa by the high digits of the second compressed mantissa;
generate target low digits by multiplying the low digits of the first compressed mantissa by the low digits of the second compressed mantissa; and
determining the target mantissa based on the first target high digits, the second target high digits, the third target high digits and the target low digits.

4. The method according to claim 3, wherein determining the target mantissa based on the first target high digits, the second target high digits, the third target high digits and the target low digits comprises:
obtaining first shifted high digits by shifting the first target high digits to left by a first preset number of bits;
obtaining two second shifted high digits by shifting the second target high digits and the third target high digits respectively to left by a second preset number of bits, wherein the second preset number of bits is less than the first preset number of bits; and
generating the target mantissa by adding the first shifted high digits, the two second shifted high digits and the target low digits.

5. The method according to claim 2, wherein generating the target mantissa by performing multiplication on the high digits and the low digits of the first compressed mantissa and the high digits and low digits of the second compressed mantissa, comprises:
calling four multiplying units to perform multiplication on the high digits and low digits of the first compressed mantissa and the high digits and low digits of the second compressed mantissa and generating four calculation results; and
performing shifting and adding on the four calculation results to generate the target mantissa.

6. The method according to claim 1, wherein compressing the mantissas of respective pieces of the data to be calculated to obtain the compressed mantissas comprises:
determining a service type of each piece of the data to be calculated;
determining a target compression number of bits corresponding to the mantissa of each piece of the data according to the service type; and
compressing the mantissa of each piece of the data, according to the target compression number of bits, to obtain the compressed mantissa.

7. The method according to claim 1, further comprising:
in a condition of the type of each piece of the data to be calculated is a type of integer, determining the number of multiplying units to be called according to the number of integer data contained in each piece of the data to be calculated; and
calling the multiplying units, according to the number of multiplying units to be called, to perform multiplication operations on respective pieces of the data to be calculated.

8. An electronic device, comprising:
at least one processor; and
a memory communicatively connected to the at least one processor; wherein,
the memory stores instructions executable by the at least one processor, and when the instructions are executed by the at least one processor, the at least one processor is configured to:
determine types of respective pieces of data to be calculated based on a multiply-add operation request;
a condition of the type of each piece of the data to be calculated is a type of single-precision floating point, compress mantissa of each piece of the data to be calculated to obtain each compressed mantissa, wherein each compressed mantissa contains less than or equal to 16 bits;
split each compressed mantissa according to a preset rule and determine high digits and low digits of the compressed mantissa; and
perform a multiply-add operation on each compressed mantissa based on the high digits and low digits of the compressed mantissa.

9. The electronic device according to claim 8, wherein the at least one processor is configured to:
generate a target mantissa by performing multiplication on high digits and low digits of a first compressed mantissa and high digits and low digits of a second compressed mantissa;
determine a target exponent based on a first exponent corresponding to the first compressed mantissa and a second exponent corresponding to the second compressed mantissa; and
determine a multiply-add operation result based on the target exponent and the target mantissa.

10. The electronic device according to claim 9, wherein the at least one processor is configured to:
generate first target high digits and second target high digits by multiplying the high digits of the first compressed mantissa by the high digits and the low digits of the second compressed mantissa respectively;
generate third target high digits by multiplying the low digits of the first compressed mantissa by the high digits of the second compressed mantissa;
generate target low digits by multiplying the low digits of the first compressed mantissa by the low digits of the second compressed mantissa; and
determine the target mantissa based on the first target high digits, the second target high digits, the third target high digits and the target low digits.

11. The electronic device according to claim 10, wherein the at least one processor is configured to:
obtain first shifted high digits by shifting the first target high digits to left by a first preset number of bits;
obtain two second shifted high digits by shifting the second target high digits and the third target high digits respectively to left by a second preset number of bits, wherein the second preset number of bits is less than the first preset number of bits; and
generate the target mantissa by adding the first shifted high digits, the two second shifted high digits and the target low digits.

12. The electronic device according to claim 9, wherein the at least one processor is configured to:
call four multiplying units to performing multiplication on the high digits and low digits of the first compressed mantissa and the high digits and low digits of the second compressed mantissa and generate four calculation results; and
perform shifting and adding on the four calculation results to generate the target mantissa.

13. The electronic device according to claim 8, wherein the at least one processor is configured to:
determine a service type of each piece of the data to be calculated;
determine a target compression number of bits corresponding to the mantissa of each piece of the data according to the service type; and
compress the mantissa of each piece of the data, according to the target compression number of bits, to obtain the compressed mantissa.

14. The electronic device according to claim 8, wherein the at least one processor is configured to:
in a condition of the type of each piece of the data to be calculated is a type of integer, determine the number of multiplying units to be called according to the number of integer data contained in each piece of the data to be calculated; and
call the multiplying units, according to the number of multiplying units to be called, to perform multiplication operations on respective pieces of the data to be calculated.

15. A non-transitory computer-readable storage medium storing computer instructions, and when the computer instructions are executed, the computer is caused to execute a method for multiply-add operations for a neural network, the method comprises:
determining types of respective pieces of data to be calculated based on a multiply-add operation request;
in a condition of the type of each piece of the data to be calculated is a type of single-precision floating point, compressing mantissa of each piece of the data to be calculated to obtain each compressed mantissa, wherein each compressed mantissa contains less than or equal to 16 bits;
splitting each compressed mantissa according to a preset rule and determining high digits and low digits of the compressed mantissa; and
performing a multiply-add operation on each compressed mantissa based on the high digits and low digits of the compressed mantissa.

16. The storage medium according to claim 15, wherein performing the multiply-add operation on each compressed mantissa based on the high digits and the low digits in the compressed mantissa comprises:
generating a target mantissa by performing multiplication on high digits and low digits of a first compressed mantissa and high digits and low digits of a second compressed mantissa;
determining a target exponent based on a first exponent corresponding to the first compressed mantissa and a second exponent corresponding to the second compressed mantissa; and
determining a multiply-add operation result based on the target exponent and the target mantissa.

17. The storage medium according to claim 16, wherein generating the target mantissa by performing multiplication on the high digits and low digits of the first compressed mantissa respectively and the high digits and low digits of the second compressed mantissa, comprises:
generating first target high digits and second target high digits by multiplying the high digits of the first compressed mantissa by the high digits and the low digits of the second compressed mantissa respectively;
generating third target high digits by multiplying the low digits of the first compressed mantissa by the high digits of the second compressed mantissa;
generate target low digits by multiplying the low digits of the first compressed mantissa by the low digits of the second compressed mantissa; and
determining the target mantissa based on the first target high digits, the second target high digits, the third target high digits and the target low digits.

18. The storage medium according to claim 17, wherein determining the target mantissa based on the first target high digits, the second target high digits, the third target high digits and the target low digits comprises:
obtaining first shifted high digits by shifting the first target high digits to left by a first preset number of bits;
obtaining two second shifted high digits by shifting the second target high digits and the third target high digits respectively to left by a second preset number of bits, wherein the second preset number of bits is less than the first preset number of bits; and
generating the target mantissa by adding the first shifted high digits, the two second shifted high digits and the target low digits.

19. The storage medium according to claim 16, wherein generating the target mantissa by performing multiplication on the high digits and the low digits of the first compressed mantissa and the high digits and low digits of the second compressed mantissa, comprises:
calling four multiplying units to perform multiplication on the high digits and low digits of the first compressed mantissa and the high digits and low digits of the second compressed mantissa and generating four calculation results; and
performing shifting and adding on the four calculation results to generate the target mantissa.

20. The storage medium according to claim 15, wherein compressing the mantissas of respective pieces of the data to be calculated to obtain the compressed mantissas comprises:
determining a service type of each piece of the data to be calculated;
determining a target compression number of bits corresponding to the mantissa of each piece of the data according to the service type; and
compressing the mantissa of each piece of the data, according to the target compression number of bits, to obtain the compressed mantissa.
